(19) United States
(12) Patent Application Publication
(10) Pub. No.: US 2009/0276992 A1
(43) Pub. Date: Nov. 12, 2009

(54) METHOD FOR MANUFACTURING RACEWAY MEMBER, METHOD FOR MANUFACTURING VALVE TRAIN AND RACEWAY MEMBER

(76) Inventors: Kikuo Maeda, Mie (JP); Hirokazu Nakashima, Mie (JP)

Correspondence Address: MCDERMOTT WILL & EMERY LLP, 600 13TH STREET, N.W., WASHINGTON, DC, 20005-3096, US

(21) Appl. No.: 12/373,379

(22) PCT Filed: Jun. 11, 2007
(86) PCT No.: PCT/JP2007/061698

§ 371 Date: Jan. 12, 2009

(30) Foreign Application Priority Data
Jul. 13, 2006 (JP) 2006-192994

(51) Int. Cl. B23P 11/00; C23C 8/32

(52) U.S. Cl. 29/428; 148/219; 148/318

(57) ABSTRACT

A method for manufacturing a raceway member, in which a hardness of a region to be plastically deformed is controllable in a stable manner and a sufficient rolling contact fatigue life is ensured by making a hardness of a region including a raceway surface sufficiently high, while suppressing increase in the manufacturing cost, includes a steel member preparation step, a heat treatment step, and a finishing step. The heat treatment step includes: a carbonitriding step, in which the steel member is heated to a carbonitriding temperature, which is a temperature not lower than A₁ point, and carbonitrided; a temperature holding step, in which the steel member is cooled from the carbonitriding temperature to a temperature range between not lower than a temperature 100° C. below A₁ point and lower than A₁ point and is held in the temperature range for not less than 60 minutes and not more than 180 minutes; and a induction hardening step, in which the high hardness region in the steel member including a region to become a raceway surface of the raceway member is induction hardened, without quench hardening of a low hardness region which is a region other than the high hardness region.

### TECHNICAL FIELD

The present invention relates to a method for manufacturing a raceway member, a method for manufacturing a valve train, and the raceway member, and more particularly, relates to a raceway member fixed to an adjoining member through plastic deformation of a part thereof, a method for manufacturing the raceway member, and a method for manufacturing a valve train provided with a cam follower having the raceway member.

### BACKGROUND ART

Generally, a rolling bearing is provided with a raceway member such as an outer ring and an inner ring, and a rolling element such as a ball or a roller arranged in contact with the raceway member. The rolling bearing is used in such a manner that at least one of the raceway members, the inner ring and the outer ring may be fixed to some other member adjoining the raceway member. The raceway member is fixed by fitting the raceway member into the other adjoining member, or also by plastic deformation such as caulking of a partial region of the raceway member.

Such fixing of the raceway member utilizing plastic deformation is more advantageous than fixing by fitting, in that it is possible, for example, to reduce the cost and the size because no additional member for fixing is needed. On the other hand, in order to fix the raceway member utilizing plastic deformation, hardness distribution in the raceway member should be carefully considered. That is, when fixing utilizing plastic deformation is carried out, the region to be plastically deformed in the raceway member needs to have a relatively low hardness, for example, a hardness not greater than 300 HV, from a viewpoint of suppressing generation of a crack at the time of plastic deformation. On the contrary, a raceway surface, which is a surface in contact with the rolling element in the raceway member, needs to have a high hardness, for example, a hardness not smaller than 653 HV (58 HRC), from a viewpoint of ensuring a sufficient rolling contact fatigue life.

In recent years, fixing of the raceway member utilizing plastic deformation is widely employed because of the above-described advantages. For example, a full-complement roller type (without a cage) radial roller bearing, which is a kind of a rolling bearing, may be employed as a cam follower with roller for a valve train activating an air-intake valve or an exhaust valve for an engine. In mounting this cam follower with roller as well, it is possible to plastically deform a partial region of the raceway member constituting the cam follower and fix the region to a retaining member in order to mount the cam follower on the retaining member. Therefore, there have been many studies regarding the rolling bearing which can be used as a cam follower with roller, for improving the lifetime and the like (Japanese Patent Laying-Open No. 2000-38907 (Patent Document 1), Japanese Patent Laying-Open No. 10-47334 (Patent Document 2), Japanese Patent Laying-Open No. 10-103339 (Patent Document 3), Japanese Patent Laying-Open No. 10-110720 (Patent Document 4), Japanese Patent Laying-Open No. 2000-38906 (Patent Document 5), Japanese Patent Laying-Open No. 2000-205284 (Patent Document 6), Japanese Patent Laying-Open No. 2002-31212 (Patent Document 7), Japanese Utility Model Laying-Open No. 63-185917 (Patent Document 8), and Japanese Patent Laying-Open No. 2002-194438 (Patent Document 9)), as well as some proposals for improving the lifetime and fixing utilizing plastic deformation at the same time (Japanese Patent Laying-Open No. 5-321616 (Patent Document 10), Japanese Patent Laying-Open No. 62-7908 (Patent Document 11), and Japanese Patent Laying-Open No. 2005-299914 (Patent Document 12)).

### Patent Document 1: Japanese Patent Laying-Open No. 2000-38907

### Patent Document 2: Japanese Patent Laying-Open No. 10-47334

### Patent Document 3: Japanese Patent Laying-Open No. 10-103339

### Patent Document 4: Japanese Patent Laying-Open No. 10-110720

### Patent Document 5: Japanese Patent Laying-Open No. 2000-38906

### Patent Document 6: Japanese Patent Laying-Open No. 2000-205284

### Patent Document 7: Japanese Patent Laying-Open No. 2002-31212

### Patent Document 8: Japanese Utility Model Laying-Open No. 63-185917

### Patent Document 9: Japanese Patent Laying-Open No. 2002-194438

### Patent Document 10: Japanese Patent Laying-Open No. 5-321616

### Patent Document 11: Japanese Patent Laying-Open No. 62-7908

### Patent Document 12: Japanese Patent Laying-Open No. 2005-299914

### DISCLOSURE OF THE INVENTION

### Problems to be Solved by the Invention

As described above, in the raceway member fixed to some other member through plastic deformation of a partial region thereof, it is required that a region including a raceway surface has a sufficient hardness, and at the same time, a region to be plastically deformed has a hardness permitting plastic deformation without generating a crack and the like. As described in above Patent Documents 10-12, however, the hardness of the region to be plastically deformed is not fully controlled simply by not quench hardening the region to be plastically deformed. The hardness of the region to be plastically deformed then varies depending on the shape of the raceway member or quantity of the raceway members that are simultaneously heat-treated, and it is impossible to keep the hardness of the region in a preferable range in a stable manner. As a result, in the actual mass production process, fixing utilizing plastic deformation may be difficult. On the other hand, as described in Patent Document 12, the hardness of the region to be plastically deformed can be fully controlled if high temperature tempering is performed after quench hardening of the entire raceway member. In this case, however, heat treatment steps increase in number and the manufacturing cost of the raceway member rises.

Therefore, it is an object of the present invention to provide a method for manufacturing a raceway member, in which a hardness of a region to be plastically deformed is controllable in a stable manner and a sufficient rolling contact fatigue life is ensured by making a hardness of a region including a raceway surface sufficiently high, while suppressing increase in the manufacturing cost. Moreover, it is another object of the present invention to provide a method for manufacturing a valve train having sufficient durability, on which a cam follower is easily mounted utilizing plastic deformation, while suppressing increase in the manufacturing cost. Moreover, it is yet another object of the present invention to provide a raceway member, in which a hardness of a region to be plastically deformed is controlled in a stable manner, and a sufficient rolling contact fatigue life is ensured with a sufficiently high hardness of a region including a raceway surface, while suppressing increase in the manufacturing cost.

### Means for Solving the Problems

A method for manufacturing a raceway member according to the present invention includes: a steel member preparation step of preparing a steel member which is a member formed of steel and generally shaped into a raceway member, a heat treatment step of heat-treating the steel member, and a finishing step of finishing the steel member heat-treated in the heat treatment step. The heat treatment step includes a carbonitriding step, a temperature holding step, and a induction hardening step. In the carbonitriding step, the steel member is heated to a carbonitriding temperature, which is a temperature not lower than A₁ point, and carbonitrided. In the temperature holding step, the steel member carbonitrided in the carbonitriding step is cooled from the carbonitriding temperature to a temperature range between not lower than a temperature 100° C. below A₁ point and lower than A₁ point, and is held in the temperature range for not less than 60 minutes and not more than 180 minutes. In the induction hardening step, following the temperature holding step, a high hardness region in the steel member including a region to become a raceway surface of the raceway member is induction hardened, without quench hardening of a low hardness region which is a region other than the high hardness region.

Generally, the steel member is cooled continuously in the case where the carbonitrided steel member is not quench hardened immediately. In that case, however, even when the same heat treatment facility is used, the cooling rate of the steel member varies depending on the shape and the size of the steel member and the amount of the other steel members that are simultaneously treated together, and the like. Moreover, depending on a shape of the steel member, the cooling rate may be different from part to part of the steel member.

In the case where the steel member heated to the temperature not lower than A₁ point is cooled without being quench hardened, the structure of steel forming the steel member basically transforms into pearlite. Here the hardness of the steel member can be suppressed, for example, to a hardness not greater than 300 HV by aggregation and coarsening of iron carbide (cementite; Fe₃C; referred to as carbide hereinafter) constituting the pearlite structure (a steel structure consisting of a ferrite phase, which is alpha iron, and iron carbide). In order to aggregate and coarsen carbide, it is effective here to set the cooling rate (temperature lowering per unit time) low in cooling the steel member.

Considering the variation of the cooling rate resulting from the shape of the steel member and the like and difference in cooling rates from part to part of the steel member as described above, however, it is not easy to control the hardness of the region to be plastically deformed in the raceway member in a stable manner, since the required cooling condition varies depending on the shape of the steel member and the like. In addition, although the hardness of the region to be plastically deformed can be suppressed in a stable manner if the cooling rate is lowered without limitation, production efficiency lowers and the manufacturing cost increases because heat treatment requires a longer time.

On the contrary, the inventors examined a heat treatment history in detail, for making the hardness of the carbonitrided steel member stable regardless of the shape and the size of the steel member and the amount of the other steel members that are simultaneously treated together and the like. As a result, the following knowledge was acquired.

That is, when the carbonitrided steel member is cooled to a temperature lower than A₁ point, coarsening and aggregation of carbide is not sufficient in the case where the steel member is cooled to a temperature range below the temperature lower by 100° C. than A₁ point in a short period of time, and it may be difficult to plastically deform the steel member without generating a crack depending on shape and the like of the steel member. Moreover, in a case where the steel member is held in the temperature range between not lower than a temperature 100° C. below A₁ point and lower than A₁ point for less than 60 minutes, pearlite transformation of steel is not completed, and fine carbide and/or layered carbide may precipitate in steel and the hardness is increased, depending on the subsequent cooling rate, and plastic deformation is difficult without generating a crack. In that temperature range, on the other hand, pearlite transformation of steel is mostly completed within 180 minutes and plastic deformation is possible without generating a crack regardless of the subsequent cooling rate. Therefore, holding the steel member in that temperature range for more than 180 minutes is less advantageous, and rather results in reducing production efficiency of the raceway member.

As described above, according to the method for manufacturing the raceway member of the present invention, in the temperature holding step, the steel member carbonitrided in the carbonitriding step of the heat treatment step is cooled to the temperature range between not lower than a temperature 100° C. below A₁ point and lower than A₁ point, and is held in the range for not less than 60 minutes and not more than 180 minutes. Therefore, the steel member is held in an appropriate temperature range for a necessary and sufficient period of time, steel forming the steel member undergoes pearlite transformation by isothermal transformation or in a condition that the cooling rate is very low, and carbide is coarsened and aggregated at the time when the transformation is mostly completed. As a result, the steel member has the hardness allowing plastic deformation without generating a crack, in a stable manner. Then, in the induction hardening step, the high hardness region including the region to become a raceway surface of the raceway member is induction hardened and partially hardened, so that easy plastic working of the region which is not quench hardened and the rolling contact fatigue life in the raceway surface of the raceway member are obtained at the same time. As a result, according to the method for manufacturing the raceway member of the present invention, the hardness of the region to be plastically deformed can be controlled in a stable manner, and a sufficient rolling contact fatigue life is ensured by making the hardness of the region including the raceway surface sufficiently high, while increase in the manufacturing cost is suppressed.

A method for manufacturing a valve train according to the present invention is a method for manufacturing a valve train having a cam follower and a retaining member retaining the cam follower, and activating at least any one of an air-intake valve and an exhaust valve of an engine. The method for manufacturing the valve train includes a cam follower manufacturing step of manufacturing a cam follower, a retaining member manufacturing step of preparing a retaining member, and a mounting step of mounting the cam follower on the retaining member. In the cam follower manufacturing step, the raceway member constituting the cam follower is manufactured by the above-described method for manufacturing the raceway member. In the mounting step, the raceway member is fixed to the retaining member through plastic working of a low hardness region, whereby the cam follower is mounted on the retaining member.

According to the method for manufacturing the valve train of the present invention, since the raceway member constituting the cam follower is manufactured by the above-described method for manufacturing the raceway member, the hardness of the region to be plastically deformed can be controlled in a stable manner, and a sufficient rolling contact fatigue life can be ensured by making the hardness of the region including the raceway surface sufficiently high, while increase in the manufacturing cost of the raceway member is suppressed. The raceway member is fixed to the retaining member through plastic working of the low hardness region of the raceway member whose hardness is controlled in a stable manner, and the cam follower is mounted on the retaining member. Therefore, a method for manufacturing a valve train having sufficient durability, resulting from a sufficient rolling contact fatigue life of the raceway member, on which a cam follower is easily mounted utilizing plastic deformation, can be provided, while increase in the manufacturing cost is suppressed.

The raceway member according to the present invention is manufactured by the above-described method for manufacturing the raceway member. According to the raceway member of the present invention, because the raceway member is manufactured by the above-described method for manufacturing the raceway member of the present invention, a raceway member can be provided, in which the hardness of the region to be plastically deformed is controlled in a stable manner and a sufficient rolling contact fatigue life is ensured with a sufficiently high hardness of a region including a raceway surface, while increase in the manufacturing cost is suppressed.

### EFFECTS OF THE INVENTION

According to the method for manufacturing the raceway member of the present invention, as clarified from the above description, the method for manufacturing the raceway member can be provided, in which the hardness of the region to be plastically deformed is controllable in a stable manner and a sufficient rolling contact fatigue life is ensured by making the hardness of the region including the raceway surface sufficiently high, while increase in the manufacturing cost is suppressed. Moreover, according to the method for manufacturing the valve train of the present invention, a method for manufacturing a valve train having sufficient durability, on which a cam follower is easily mounted utilizing plastic deformation, can be provided, while increase in the manufacturing cost is suppressed. Moreover, according to the raceway member of the present invention, a raceway member can be provided, in which the hardness of the region to be plastically deformed is controlled in a stable manner, and a sufficient rolling contact fatigue life is ensured with a sufficiently high hardness of a region including a raceway surface, while increase in the manufacturing cost is suppressed.

### BRIEF DESCRIPTION OF THE DRAWINGS

FIG. 1 is a schematic diagram showing a structure of a valve train provided with a cam follower including a raceway member according to a first embodiment.

FIG. 2 is a schematic cross sectional view taken along a line segment II-II in FIG. 1.

FIG. 3 is a schematic, partial cross sectional view enlarging an area around the cam follower in FIG. 2.

FIG. 4 is a diagram showing outlines of a method for manufacturing a shaft of the cam follower in the first embodiment.

FIG. 5 is a diagram showing a heat treatment step included in the method for manufacturing the shaft of the cam follower in the first embodiment.

FIG. 6 is a diagram showing outlines of a method for manufacturing a valve train 10 in the first embodiment.

FIG. 7 is a schematic diagram showing a structure of a valve train provided with a cam follower including a raceway member in a second embodiment.

FIG. 8 is a schematic diagram showing a structure of a valve train provided with a cam follower including a raceway member in a third embodiment.

FIG. 9 is a schematic diagram enlarging an area around the cam follower in FIG. 8.

FIG. 10 is a diagram showing locations for measurement of a hardness of a test sample.

FIG. 11 is a schematic diagram showing a principal part of a rolling contact fatigue life tester used for testing in the second example.

### DESCRIPTION OF THE REFERENCE SIGNS

1 cam follower, 2 rocker arm, 2B one end, 2C other end, 2D through hole, 3 rocker arm shaft, 4 bearing metal, 5 cam, 5A cam shaft, 5B outer circumferential surface, 6 valve, 7 spring, 8 lock nut, 9 adjustment screw, 10 valve train, 11 roller, 11A roller raceway surface, 12 shaft, 12A shaft raceway surface, 12B high hardness region, 12C low hardness region, 13 roller, 13A roller rolling contact surface, 21 side wall, 21A through hole, 21B tapered portion, 22 pivot abutting portion, 30 shaft of cam follower, 31 raceway surface, 32 high hardness region, 40 rolling contact fatigue life tester, 41 rotation shaft, 42 driving roller, 42A outer circumferential surface, 43 outer ring, 44 roller, 45 bearing, 80 adjustment screw, 81 joint member, 82 lock nut, 90 push rod.

### BEST MODES FOR PERFORMING THE INVENTION

Embodiments of the present invention will be described hereinafter with reference to the drawings. Note that, in the following drawings, the same or corresponding elements have the same reference characters allotted and description thereof will not be repeated.

### First Embodiment

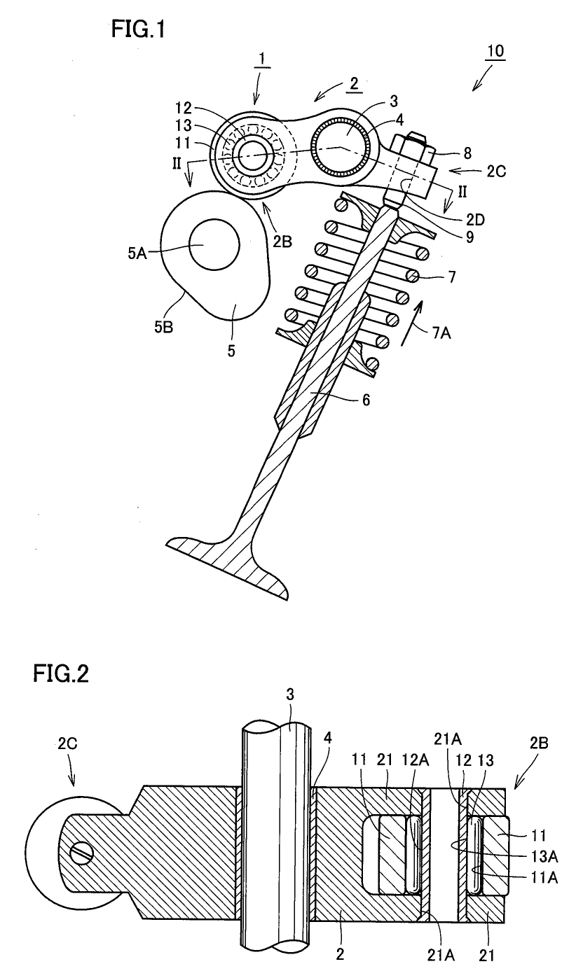

First, with reference to FIGS. 1-3, a valve train provided with a cam follower including a raceway member in a first embodiment is described.

Referring to FIGS. 1 and 2, a valve train 10 includes a cam follower 1 which is a full-complement roller type radial roller bearing, a rocker arm 2 as a retaining member retaining cam follower 1 at one end 2B, a cam 5 arranged such that an outer circumferential surface 5B of cam 5 is in contact with an outer circumferential surface of a roller 11 serving as an outer ring of cam follower 1, an adjustment screw 9 inserted in a through hole 2D formed at other end 2C of rocker arm 2 and fixed to rocker arm 2 with a lock nut 8, and a valve 6 which is an air-intake valve or an exhaust valve of an engine, connected at its one end to one end of adjustment screw 9.

Cam follower 1 includes annular roller 11 as an outer ring, a hollow cylindrical shaft 12 penetrating roller 11, and a plurality of rollers 13 arranged between roller 11 and shaft 12. Rocker arm 2 is held at the central portion by a rocker arm shaft 3 with a bearing metal 4 and the like being interposed and pivotable around rocker arm shaft 3. Valve 6 is biased by elastic force of a spring 7 to the direction of an arrow 7A. Therefore, cam follower 1 is always pressed against outer circumferential surface 5B of cam 5 by elastic force of spring 7 with adjustment screw 9 and rocker arm 2. Cam 5 has an egg-like cross-sectional shape in a cross section perpendicular to an axial direction of shaft 12 which is an inner ring of cam follower 1. Cam 5 is formed integrally with cam shaft 5A and configured to be rotatable around cam shaft 5A.

With reference to FIG. 2, one end 2B of rocker arm 2 is bifurcated with a pair of side walls 21 formed. A coaxial cylindrical through hole 21A is formed in each of the pair of side walls 21. Shaft 12 of cam follower 1 is fitted to penetrate both through holes 21A of the pair of side walls 21. Shaft raceway surface 12A is formed on the outer circumferential surface of shaft 12, and the plurality of rollers 13 are arranged in contact with shaft raceway 12A on a roller rolling contact surface 13A, which is an outer circumferential surface of the roller. Furthermore, roller 11 is arranged between the pair of side walls 21, and a roller raceway surface 11A is formed on an inner circumferential surface of roller 11, opposite to shaft raceway surface 12A. Roller 13 is arranged in contact with roller raceway surface 11A on roller rolling contact surface 13A. Thus, roller 11 is held rotatably with respect to shaft 12.

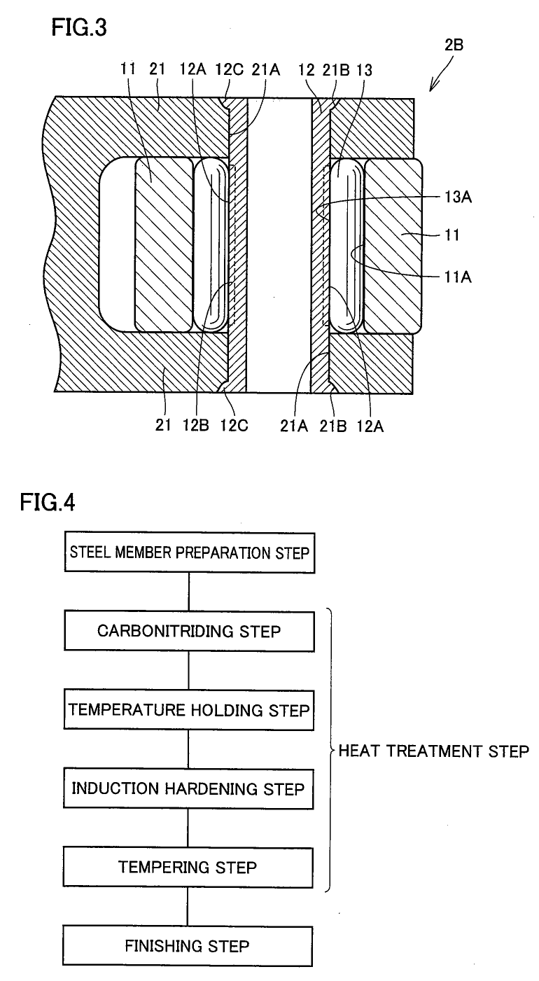

Furthermore, with reference to FIG. 3, a tapered portion 21B with a gradually increasing diameter at a cross section perpendicular to shaft 12 in an axial direction is formed in the vicinity of each aperture of through hole 21A on the outer wall side. Opposing ends of shaft 12 form a low hardness region 12C with the hardness not greater than 300 HV, and are deformed by caulking, which is plastic working, to conform to tapered portion 21B. Thus, shaft 12 as a raceway member is fixed to rocker arm 2 as a retaining member. On the other hand, an annular region including shaft raceway surface 12A of shaft 12 is induction hardened and forms a high hardness region 12B with the hardness not smaller than 653 HV.

Although a case with hollow shaft 12 employed for reducing the weight is shown in FIGS. 1-3, solid shaft 12 may be employed instead, if strength, rigidity, and the like is regarded as more important.

Now the operation of valve train 10 in the first embodiment is described. With reference to FIG. 1, when cam 5 rotates together with cam shaft 5A around cam shaft 5A, a distance from cam shaft 5A to a contact portion of cam 5 and cam follower 1 changes periodically. Therefore, rocker arm 2 swings with rocker arm shaft 3 serving as a fulcrum. As a result, valve 6 reciprocates with adjustment screw 9. Thus, the air-intake valve or the exhaust valve of the engine opens and closes.

Now a method for manufacturing shaft 12 of cam follower 1 as a raceway member and valve train 10 in the first embodiment is described.

With reference to FIG. 4, in the method for manufacturing the shaft of the cam follower according to the first embodiment, a steel member preparation step is performed first of all, in which a steel member formed of steel and generally shaped into shaft 12 as a raceway member is prepared. Specifically, a steel material formed of bearing steel such as JIS SUJ2, chromium-molybdenum steel such as SCM420, or chrome steel such as SCr420 is worked by forging, cutting, or the like, to produce the steel member.

Next, a heat treatment step is performed, in which the steel member prepared in the steel member preparation step is heat-treated. The heat treatment step includes a carbonitriding step, a temperature holding step, a induction hardening step, and a tempering step. The detail of this heat treatment step will be described later.

A finishing step is then performed, in which the steel member heat-treated in the heat treatment step is finished. Specifically, shaft 12 of cam follower 1 is completed by finishing, such as grinding and super-finishing, of the steel member for which the heat treatment has been completed.

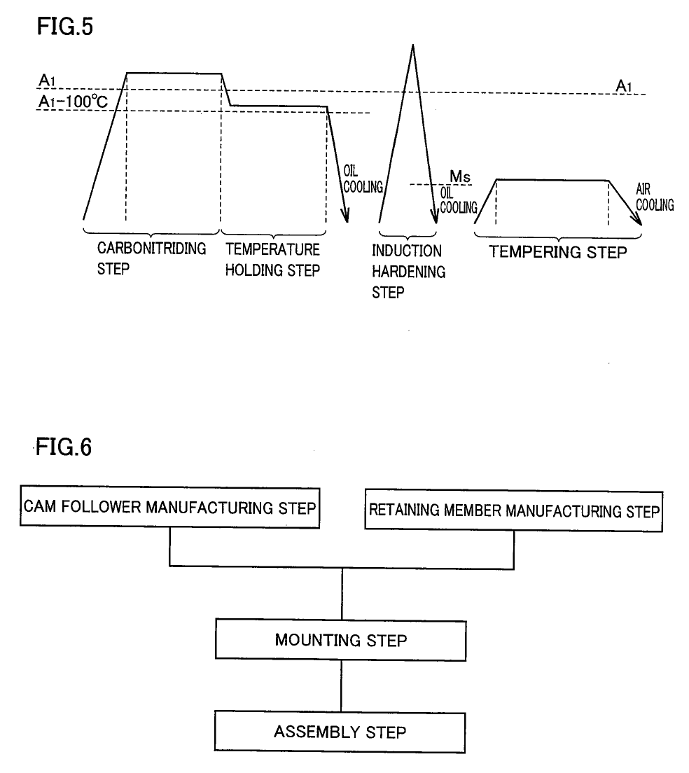

Details of the heat treatment step included in the method for manufacturing the shaft of the cam follower according to the first embodiment are now described. In FIG. 5, the horizontal direction shows time and lapse of time is shown towards the right. Moreover in FIG. 5, the perpendicular direction shows a temperature and the upward direction shows higher temperature.

In the heat treatment step, with reference to FIG. 5, the carbonitriding step is first performed, in which the steel member is carbonitrided by being heated to the carbonitriding temperature which is the temperature not lower than A₁ point. Specifically, the steel member prepared in the steel member preparation step is heated to a temperature not lower than 800° C. and not higher than 1000° C., which is a temperature not lower than A₁ point, for example 850° C., and is held for not less than 60 minutes and not more than 300 minutes, for example 150 minutes. At this time, as a result of heating in an atmosphere of RX gas with ammonia (NH₃) added thereto, the carbon concentration and nitrogen concentration of the surface part of the steel member are adjusted to a desired concentration.

The temperature holding step is then performed, in which the steel member carbonitrided in the carbonitriding step is cooled from the carbonitriding temperature to a temperature range between not lower than a temperature 100° C. below A₁ point and lower than A₁ point and is held in the temperature range for not less than 60 minutes and not more than 180 minutes.

At this time, steel forming the steel member starts pearlite transformation by being cooled to a temperature lower than A₁ transformation point. Pearlite transformation proceeds as time passes, even if the temperature is not lowered. Therefore, the transformation of steel forming the steel member is mostly completed by being held in the above temperature range for not less than 60 minutes and not more than 180 minutes as described above, while the condition of isothermal transformation or such a condition that the cooling rate is very low is maintained. As a result, carbide in steel is sufficiently coarsened and aggregated, and the hardness is suppressed.

Moreover, it is possible to coarsen and aggregate carbide in a constant condition regardless of the shape and the size of the steel member and the amount of the other steel members that are simultaneously treated together, because the temperature of the steel member is held in the above temperature range during the period when pearlite transformation proceeds. Furthermore, it is possible to coarsen and aggregate carbide in a constant condition regardless of the part of the steel member because the cooling rate does not vary greatly from part to part. As a result, the hardness of low hardness region 12C of shaft 12 can be controlled in a stable manner, and shaft 12 having low hardness region 12C allowing plastic working without generating a crack can be manufactured in a stable manner. In addition, since the heat treatment step can be more simplified than the conventional step of performing quenching and high temperature tempering after carbonitriding, increase in the manufacturing cost can be suppressed.

As for the temperature at which the steel member should be held in the temperature holding step, a temperature not lower than 650° C. and not higher than 720° C. is specifically preferable, from the viewpoint of sufficiently proceeding with coarsening and aggregation of carbide. In more detail, the preferable temperature at which the steel member is held more or less varies depending on the kind of steel the steel member is formed of For example, a temperature not lower than 650° C. and not higher than 700° C. is preferable for JIS SUJ2, and a temperature not lower than 670° C. and not higher than 700° C. is preferable for SCM 420. Additionally, as for the period of time during which the steel member is held in the above-described temperature range in the temperature holding step, it is preferable to set the time duration to not less than 60 minutes and not more than 120 minutes, from the viewpoint of achieving improvement in production efficiency, sufficient progress of pearlite transformation and suppression of variation of the cooling rate, at the same time.

Next with reference to FIG. 5, the steel member for which the temperature holding step has been performed is cooled to a temperature at which the steel member is easily handled, for example a room temperature. Now since pearlite transformation of steel forming the steel member has mostly been completed in the temperature holding step as described above, the cooling rate hardly affects the hardness of the steel member. Therefore, in order to improve production efficiency, the steel member can be rapidly cooled, for example, by oil cooling, water cooling, or the like.

Next, for the steel member, a induction hardening step is performed, in which high hardness region 12B including a region to become shaft raceway surface 12A of shaft 12 as the raceway member is induction hardened without quench hardening of low hardness region 12C (both ends) which is a region other than high hardness region 12B. Specifically, the steel member is set in a induction hardening apparatus such that a surface of high hardness region 12B is opposite to an induction coil, and high hardness region 12B is induction-heated to a temperature not lower than 800° C. and not higher than 1000° C., which is a temperature not lower than A₁ point such as 900° C., by feeding high frequency current to the induction coil. Then the steel member is rapidly cooled, for example, by oil cooling or water cooling from the temperature range not lower than A₁ point to a temperature lower than Mₛ point. High hardness region 12B is thereby quench hardened without quench hardening of low hardness region 12C. Now the surface part of the steel member including high hardness region 12B has been carbonitrided in the carbonitriding step. Therefore, by induction hardening high hardness region 12B in the induction hardening step, shaft raceway surface 12A is turned into a region with high resistance to rolling contact fatigue, and shaft 12 can be provided with an excellent rolling contact fatigue life property.

Moreover, the surface part directly under shaft raceway surface 12A comes to have a steel structure containing retained austenite of not less than 10 volume % and not more than 50 volume %, or not less than 15 volume % and not more than 35 volume %, which is a more preferable range, with austenite grain size being not smaller than No. 11 (the grain size number of prior austenite grain; JIS G 0551), by being induction hardened after being carbonitrided. Therefore, the rolling contact fatigue life property of shaft 12 is further improved. Note that a surface part means a region whose distance from the raceway surface is within 0.2 mm.

Here the above induction heating in the induction hardening step is implemented here by Joule's heat resulting from eddy current generated inside shaft 12 which is a workpiece, and the heat equivalent to work with hysteresis loss, and thus it is possible to heat only a desired part of shaft 12 locally by controlling the frequency of the high frequency current fed to the induction coil, the output of the power source, the heating time, and the like. Therefore, high hardness region 122B can be easily quench hardened without quench hardening of low hardness region 12C.

Next with reference to FIG. 5, a tempering step is performed. Specifically, the steel member for which the induction hardening step has been performed is heated to a temperature not lower than 150° C. and not higher than 350° C., which is a temperature lower than A₁ point such as 180° C., held for not less than 30 minutes and not more than 240 minutes, for example 120 minutes, and then cooled in the air at a room temperature (air cooled). The heat treatment step included in the manufacturing step of the raceway member according to the first embodiment is completed through the above-described procedure.

According to the method for manufacturing shaft 12 as a raceway member in the above first embodiment, it is possible to make the hardness of high hardness region 12B including carbonitrided raceway surface 12A sufficiently high and to provide raceway surface 12A with a sufficient rolling contact fatigue life property, while suppressing increase in the manufacturing cost. It is also possible to make both ends of shaft 12 (low hardness region 12C) plastically deformable while avoiding generation of a crack, by controlling and suppressing the hardness of low hardness region 12C, that is both ends of shaft 12, in a stable manner, and to manufacture shaft 12 which is easily fixed through plastic deformation

Shaft 12 as a raceway member in the first embodiment of the present invention manufactured by the method for manufacturing the raceway member according to the above first embodiment serves as a raceway member with the hardness of the region including a raceway surface being sufficiently high to ensure a sufficient rolling contact fatigue life, and with the hardness of the region to be plastically deformed being controlled in a stable manner, while increase in the manufacturing cost is suppressed.

A₁ point here means a point corresponding to a temperature where a steel structure starts transformation from ferrite to austenite when steel is heated, while Mₛ point means a point corresponding to a temperature where steel transformed into austenite starts transformation to martensite, when the steel is cooled.

A method for manufacturing valve train 10 according to the first embodiment will be described hereinafter. With reference to FIGS. 1 and 6, the method for manufacturing valve train 10 in the first embodiment is a manufacturing method of a valve train which has cam follower 1 and rocker arm 2 as a retaining member for retaining cam follower 1, and activates valve 6, which is an air-intake valve or an exhaust valve of an engine (not shown). The method for manufacturing valve train 10 includes a cam follower manufacturing step of manufacturing cam follower 1, a retaining member manufacturing step of manufacturing rocker arm 2 as a retaining member, a mounting step of mounting cam follower 1 on rocker arm 2 as a retaining member, and an assembling step of assembling valve train 10 by combining rocker arm 2 provided with the cam follower, with cam 5, valve 6, spring 7, and the like, which are separately prepared.

In the cam follower manufacturing step here, shaft 12 as a raceway member constituting cam follower 1 is manufactured by the method for manufacturing the raceway member according to the above-described first embodiment.

Moreover, in the mounting step, with reference to FIG. 3, by plastic working of low hardness region 12C which is both ends of shaft 12, shaft 12 is fixed to rocker arm 2 and cam follower 1 is mounted on rocker arm 2. Stating in more detail, roller 11 and the plurality of rollers 13 arranged in contact with raceway surface 11A of roller 11 are inserted between the pair of side walls 21 formed at one end 2B of rocker arm 2. Shaft 12 is then inserted such that it simultaneously penetrates holes 21A formed in the pair of side walls 21 respectively and shaft raceway surface 12A contacts the plurality of rollers 13. Thereafter by caulking, which is a kind of plastic working, of low hardness region 12C, which is both ends of shaft 12, shaft 12 is fixed to rocker arm 2 and cam follower 1 is mounted on rocker arm 2.

In the method for manufacturing valve train 10 according to the first embodiment, shaft 12 is manufactured by the above-described manufacturing method of the raceway member according to the first embodiment, shaft 12 is fixed to rocker arm 2 by being caulked, and cam follower 1 is mounted on rocker arm 2. Therefore, in the method for manufacturing valve train 10 according to the first embodiment, a method for manufacturing valve train 10 having sufficient durability because shaft 12 as a raceway member has a sufficient rolling contact fatigue life, on which a cam follower is easily mounted utilizing plastic deformation, can be provided, while increase in the manufacturing cost is suppressed.

### Second Embodiment

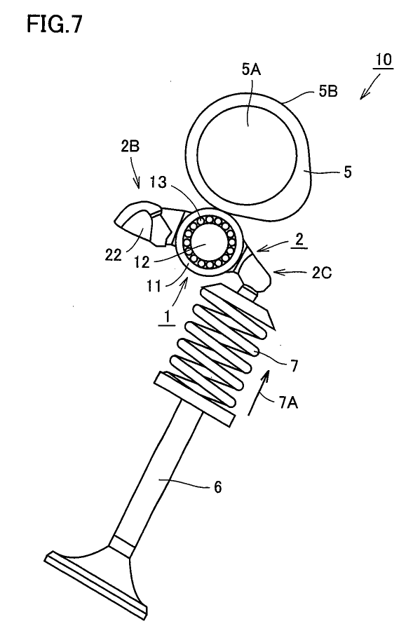

Next with reference to FIG. 7, a valve train provided with a cam follower including a raceway member and a method for manufacturing the valve train according to a second embodiment will be described hereinafter.

With reference to FIG. 7, valve train 10 according to the second embodiment has basically the same configuration as valve train 10 in the above-described first embodiment. Valve train 10 in the second embodiment, however, is different from valve train 10 in the first embodiment in that one end 2B of rocker arm 2 serves as a fulcrum of pivot of rocker arm 2.

That is, in valve train 10 according to the second embodiment, a pivot abutting portion 22, to which a not-shown pivot abuts is formed at one end 2B of rocker arm 2. Rocker arm 2 is then held rotatably with pivot abutting portion 22 serving as a fulcrum.

When cam 5 rotates together with cam shaft 5A around cam shaft 5A, the distance from cam shaft 5A to the contact portion of cam 5 and cam follower 1 changes periodically. Therefore, rocker arm 2 swings with pivot abutting portion 22 serving as a fulcrum. As a result, valve 6 reciprocates, and the air-intake valve or the exhaust valve of the engine opens and closes.

Note that shaft 12 as a raceway member and valve train 10 in the second embodiment have, basically the same configuration as shaft 12 and valve train 10 in the first embodiment as described above, and can be manufactured by a similar manufacturing method.

### Third Embodiment

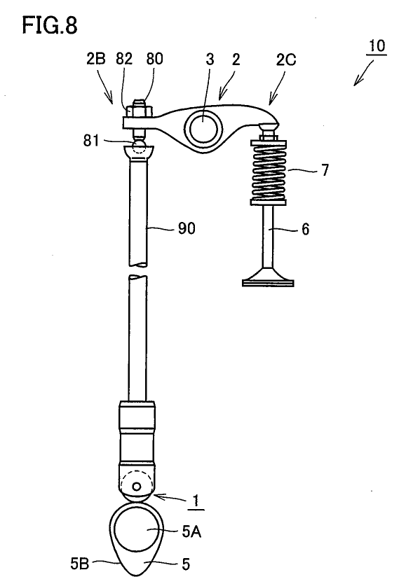

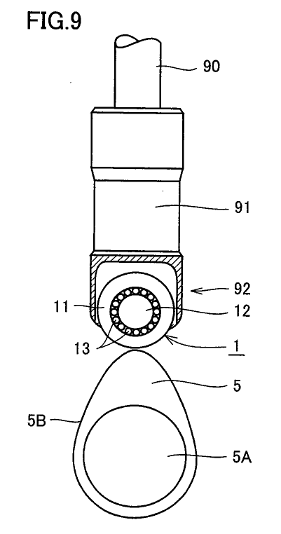

Next with reference to FIGS. 8 and 9, a valve train provided with a cam follower including a raceway member in a third embodiment and a method for manufacturing the valve train will be described hereinafter.

With reference to FIGS. 8 and 9, valve train 10 in the third embodiment has basically the same configuration as valve train 10 in the above-described first embodiment. Valve train 10 in the third embodiment, however, is different from valve train 10 in the first embodiment in that cam follower 1 is not directly mounted on rocker arm 2 but a push rod 90 is interposed between rocker arm 2 and cam follower 1 and cam follower 1 is mounted on push rod 90.

That is, push rod 90 having a bar shape is connected to one end 2B of rocker arm 2 with an adjustment screw 80 fixed to rocker arm 2 with a lock nut 82 and a joint member 81. On push rod 90 as a retaining member, cam follower 1 is mounted on an end which is opposite to the end to which rocker arm 2 is connected. Cam 5 is arranged in contact with the outer circumferential surface of roller 11 of cam follower 1 on outer circumferential surface 5B.

When cam 5 rotates together with cam shaft 5A around cam shaft 5A, the distance from cam shaft 5A to the contact portion of cam 5 and cam follower 1 changes periodically. Therefore, one end 2B of rocker arm 2 is pushed by push rod 90 and rocker arm 2 swings with rocker arm shaft 3 serving as a fulcrum. As a result, valve 6 reciprocates and the air-intake valve or the exhaust valve of the engine opens and closes.

Note that shaft 12 as a raceway member and valve train 10 in the third embodiment have basically the same configuration as shaft 12 and valve train 10 in the first embodiment as described above, and can be manufactured by a similar manufacturing method.

### Example 1

Example 1 of the present invention will be described hereinafter. The property of the raceway member manufactured by the method for manufacturing the raceway member according to the present invention was tested for evaluation. The procedure of the test was as follows.

First of all, the method for fabricating a test sample to be tested will be described. As an example of the present invention, a solid, columnar test sample (a shaft of a cam follower) with the outer diameter of 14.6 mm and the length of 17.3 mm was fabricated, by employing JIS SUJ2 bearing steel as a raw material, with a manufacturing method similar to the manufacturing method of shaft 12 as a raceway member in the first embodiment described based on FIGS. 4 and 5. In the heat treatment step, with reference to FIG. 5, the test sample was heated to 850° C., which was a temperature not lower than A₁ point, and carbonitrided (the carbonitriding step), then cooled to 650° C., which was not lower than a temperature 100° C. below A₁ point and lower than A₁ point, and thereafter held at 650° C. for 120 minutes (the temperature holding step). Subsequently, the test sample was cooled (oil-cooled) by being immersed into oil. Furthermore, after induction hardening in which the region including a region to become a raceway surface was quench hardened (the induction hardening step), tempering was performed by heating the test sample to 180° C. and holding it for 120 minutes (the tempering step), and the heat treatment step was completed (examples A and B).

On the other hand, test samples as comparative examples outside the scope of the present invention (comparative examples A and B) were also fabricated, for which only the induction hardening step and the tempering step were performed, with the carbonitriding step and the temperature holding step of the heat treatment step being omitted, in the steps similar to the above-described steps for the test samples.

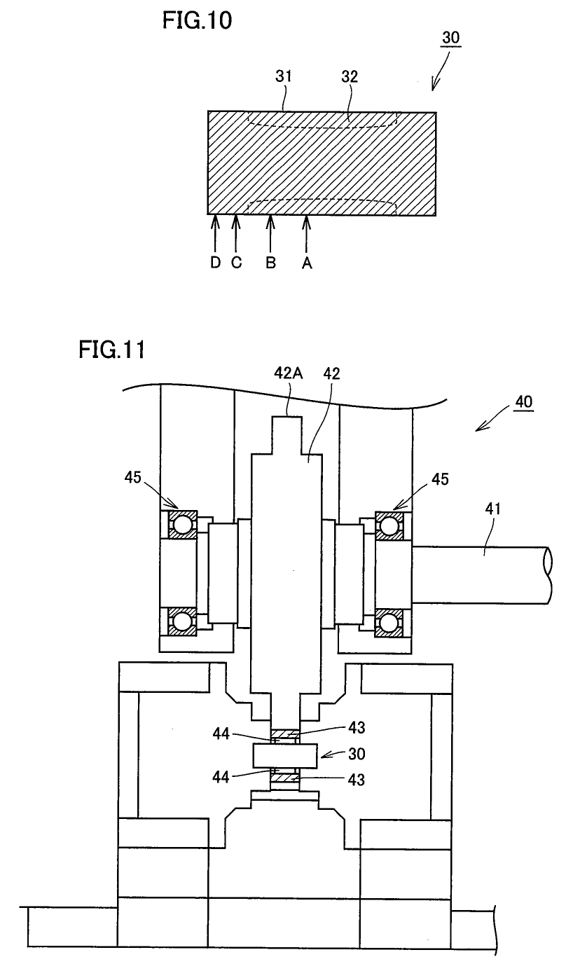

Next, the method for property evaluation will be described. The hardness of the outer circumferential surface, the amount of retained austenite on the raceway surface and the austenite grain size number of the above-described test sample were investigated. With reference to FIG. 10, the hardness of the outer circumferential surface of shaft 30 of the cam follower as a test sample was measured with a Vickers hardness tester at measurement locations A, B, C, and D, which were 8.65 mm, 5.0 mm, 2.0 mm, and 1.0 mm away from an end of the outer circumferential surface in the longitudinal direction, respectively. Measurement locations A and B were the locations included in raceway surface 31, which was a surface of high hardness region 32, and measurement locations C and D were the locations included in a region other than raceway surface 31.

The amount of retained austenite on raceway surface 31 was calculated by measuring diffraction intensity of martensite a (211) plane and austenite y (220) plane of raceway surface 31, using an X-ray diffraction meter (XRD). Moreover, the austenite grain size number was measured based on the measuring method of the grain size number of prior austenite grain described in JIS G 0551.

TABLE 1

| | | | | Comparative | Comparative |
|---|---|---|---|---|---|
| | | Example A | Example B | example A | example B |
| Hardness | Measurement | 790 | 795 | 780 | 775 |
| (HV) | location A | | | | |
| | Measurement | 805 | 800 | 735 | 780 |
| | location B | | | | |
| | Measurement | 230 | 235 | 220 | 220 |
| | location C | | | | |
| | Measurement | 220 | 235 | 210 | 200 |
| | location D | | | | |

| | | | | |
|---|---|---|---|---|
| Amount of retained | 31.5 | 32.5 | 7.5 | 8.5 |
| austenite | | | | |
| (volume %) | | | | |
| Austenite grain size No. | 12 | 12 | 10.5 | 11 |

Table 1 shows the result of the property evaluation. With reference to Table 1, in examples A and B which were fabricated according to the method for manufacturing the example of the present invention, the hardness at measurement locations A and B, which were included in raceway surface 31 was 790-805 HV, in which improvement in a rolling contact fatigue life could be expected. Moreover, the hardness at measurement locations C and D in a region other than raceway surface 31 was 220-235 HV, which was not greater than 300 HV in the hardness range allowing plastic working such as caulking without generating a crack.

On the other hand, in comparative examples A and B fabricated by the conventional manufacturing method outside the scope of the present invention, the hardness at measurement locations A and B included in raceway surface 31 was 735-780 HV. It is contemplated that the hardness was lower than in examples A and B because the test sample in comparative examples A and B was not carbonitrided. Moreover, the hardness at measurement locations C and D in a region other than raceway surface 31 was 200-220 HV.

Moreover, in examples A and B, the amount of retained austenite on raceway surface 31 was 31.5-32.5 volume %. This is included in a preferable range of not less than 10 volume % and not more than 50 volume %, and in a more preferable range of not less than 15 volume % and not more than 35 volume %, for achieving both improvement in the rolling contact fatigue life, particularly the rolling contact fatigue life in a contaminated environment and the like where hard foreign substances are mixed into a lubricant and dimensional stability at the same time.

On the other hand, in comparative examples A and B, the amount of retained austenite on raceway surface 31 was 7.5-8.5 volume %. It is contemplated that the amount of retained austenite was lower than in examples A and B because the test sample in comparative examples A and B was not carbonitrided. As a result, the amount of retained austenite in comparative examples A and B was out of the preferable range, which was not less than 10 volume % and not more than 50 volume %, for achieving both improvement in the rolling contact fatigue life, particularly the rolling contact fatigue life in a contaminated environment and the like with foreign substances mixed in, and dimensional stability at the same time.

Moreover, in examples A and B, the grain size number of austenite grains on raceway surface 31 was 12, which was in a preferable range not smaller than 11, for improving the rolling contact fatigue life, toughness, and the like.

On the other hand, in comparative examples A and B, the grain size number of austenite grains on raceway surface 31 was 10.5-11. It is contemplated that the grain size number was smaller (prior austenite grain was greater) than in examples A and B because the test sample in comparative examples A and B was not carbonitrided and number density of carbide serving as a site where austenite grain is formed in induction hardening was smaller than number density in examples A and B.

As described above, the raceway member fabricated by the method for manufacturing the raceway member according to the present invention had a higher hardness and a greater austenitic grain size number on the raceway surface than the conventional raceway member, the amount of retained austenite was in the preferable range, and a region of which plastic working was easy was formed therein. Therefore, it was ensured that the raceway member fabricated by the method for manufacturing the raceway member according to the present invention had an excellent rolling contact fatigue life on the raceway surface and it was easy to fix the raceway member utilizing plastic working such as caulking.

### Example 2

Example 2 of the present invention will be described hereinafter. The rolling contact fatigue life of the raceway member manufactured by the method for manufacturing the raceway member according to the present invention was tested for investigation. The procedure of the test was as follows.

The rolling contact fatigue life test for an outer-ring rotation type was conducted with the shaft of the cam follower fabricated as the test sample shown in FIG. 10 in above-described Example 1 serving as an inner ring. The testing method for the rolling contact fatigue life test in Example 2 will now be described with reference to FIG. 11.

With reference to FIG. 11, a rolling contact fatigue life tester 40 includes a rotating shaft 41 connected to a not-shown source of power, a disc-like driving roller 42 with rotating shaft 41 penetrating a region including the center, which is configured to be rotatable together with rotating shaft 41, and a pair of bearings 45 supporting rotating shaft 41 rotatably around the shaft.

An annular, outer ring 43 is arranged such that its outer circumferential surface comes in contact with an outer circumferential surface 42A of the driving roller, and a plurality of rollers 44 are arranged such that their outer circumferential surfaces come in contact with an inner circumferential surface of outer ring 43. Furthermore, with reference to FIGS. 10 and 11, shaft 30 of the cam follower as a test sample is fixedly arranged to penetrate outer ring 43 and to contact rollers 44 on raceway surface 31.

When rotating shaft 41 rotates around the axis using the not-shown source of power, driving roller 42 rotates together with rotating shaft 41. Outer ring 43 then rotates, by being driven by driving roller 42. As a result, roller 44 rolls on raceway surface 31 of fixed shaft 30 of the cam follower. Now the test was performed under the condition that the load imposed on shaft 30 of the cam follower was set to 2200 N, the revolution rate of outer ring 43 was set to 7000 rpm, an engine oil was employed as the lubricant oil (SAE viscosity grades: 10W-30), and the oil temperature was set to 100° C. According to this condition, either surface damage or internally originating flaking occurs during the test. Therefore, a lifetime can be checked through the test for both surface damage and internally originating flaking. The period of time before flaking occurred at shaft 30 of the cam follower (rolling contact fatigue life) was investigated. Furthermore, the rolling contact fatigue life obtained as a result of the experiment was analyzed statistically, and the period of time before flaking occurred in 10% of the test samples (L10 lifetime) was calculated. Table 2 shows the test results.

TABLE 2

| Test sample | L10 lifetime ratio |
|---|---|
| Example A | 3.0 |
| Example B | 3.4 |
| Comparative example A | 1.0 |
| Comparative example B | 1.2 |

In Table 2, the lifetime ratio of each test sample is shown assuming that the L10 lifetime of comparative example A as 1. With reference to Table 2, the shaft of the cam follower of examples A and B, which are the examples of the present invention, has a rolling contact fatigue life about three times longer than the rolling contact fatigue life of comparative examples A and B with the conventional shaft of the cam follower. It is contemplated that this is because carbonitriding treatment is performed for examples A and B as described above, whereby the austenite grain size was small and the amount of retained austenite was within the preferable range.

It was confirmed, based on the result of above Examples 1 and 2, that, according to the method for manufacturing the raceway member of the present invention, it was possible to allow the material of the region including the raceway surface to have a sufficiently high hardness and to be highly resistant to the rolling contact fatigue, by carbonitriding and induction hardening, and to control and suppress the hardness of a region other than the raceway surface in a stable manner, and a raceway member which was easily fixed utilizing plastic deformation could be manufactured, while suppressing increase in the manufacturing cost by not increasing the heat treatment steps in number.

The embodiments and examples disclosed herein are by way of example in all respects and should not be interpreted as restrictive. The scope of the present invention is determined not by the above description but by the appended claims, and intended to include all the modifications within the meaning and the scope equivalent to those of the claims.

### INDUSTRIAL APPLICABILITY

The raceway member and the method for manufacturing the raceway member of the present invention can be applied particularly advantageously to the raceway member which is fixed to the adjoining member through plastic deformation of a part thereof, and to the manufacturing method. Moreover, the method for manufacturing the valve train of the present invention can be applied particularly advantageously to the manufacturing method of the valve train provided with the cam follower having the raceway member fixed to the adjoining member through plastic deformation of a part thereof.

1. A method for manufacturing a raceway member comprising:
a steel member preparation step of preparing a steel member which is a member formed of steel and generally shaped into a raceway member;
a heat treatment step of heat treating said steel member; and
a finishing step of finishing said steel member heat-treated in said heat treatment step,
said heat treatment step including
a carbonitriding step in which said steel member is heated to a carbonitriding temperature, which is a temperature not lower than A₁ point, and carbonitrided, a temperature holding step in which said steel member carbonitrided in said carbonitriding step is cooled from said carbonitriding temperature to a temperature range between not lower than a temperature 100° C. below A₁ point and lower than A₁ point, and is held in said temperature range for not less than 60 minutes and not more than 180 minutes, and
a induction hardening step, following said temperature holding step, in which a high hardness region in said steel member including a region to become a raceway surface of said raceway member is induction hardened, without quench hardening of a low hardness region which is a region other than said high hardness region.

2. A method for manufacturing a valve train having a cam follower and a retaining member retaining said cam follower, and activating at least any one of an air-intake valve and an exhaust valve of an engine, comprising:
a cam follower manufacturing step of manufacturing said cam follower;
a retaining member manufacturing step of manufacturing a retaining member; and
a mounting step of mounting said cam follower on said retaining member,
in said cam follower manufacturing step the raceway member constituting said cam follower being manufactured by the method for manufacturing the raceway member according to claim 1, and
in said mounting step said raceway member being fixed to said retaining member through plastic working of said low hardness region, and said cam follower being mounted on said retaining member.

3. The raceway member manufactured by the method for manufacturing the raceway member according to claim 1.
